(19) United States
(12) Patent Application Publication
(10) Pub. No.: US 2007/0245414 A1
(43) Pub. Date: Oct. 18, 2007

(54) Proxy Authentication and Indirect Certificate Chaining

(75) Inventors: Kok Wai Chan, Bellevue, WA (US); Colin Chow, Bellevue, WA (US); Trevin M. Chow, Redmond, WA (US); Lin Huang, Redmond, WA (US); Naresh Jain, Redmond, WA (US); Wei Jiang, Redmond, WA (US); Yordan I. Rouskov, Kirkland, WA (US); Pui-Yin Winfred Wong, Redmond, WA (US); Ismail Cem Paya, Gainesville, FL (US); Ryan Hurst, Woodinville, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/279,869

(22) Filed: Apr. 14, 2006

(51) Int. Cl. G06F 15/16

(52) U.S. Cl. 726/12

(57) ABSTRACT

Embodiments of proxy authentication and indirect certificate chaining are described herein. In an implementation, authentication for a client occurs via a proxy service. Proxy service communicates between client and server, and caches security tokens on behalf of the client. In an implementation, trustworthiness of certificate presented to a client to establish trust is determined utilizing a signed data package which incorporates a plurality of known certificates. The presented certificate is verified without utilizing root certificates installed on the client device.

### BACKGROUND

User may user a variety of devices to access resources. Mobile electronic devices such as laptop computers, wireless phones, personal digital assistants, wireless devices, gaming systems, and audio players have become increasingly popular. Users may use one or more of these devices for various activities such as to communicate, one to another, through the use of email, instant messaging, and so forth. Further, users may use one or more of these devices to access a variety of content via a network. However, the compact size of portable electronic devices may hinder user activities.

For instance, certain client devices may have limited computing power, memory and so forth. To access certain protected content or services, authentication may be required. However, transactions involved in authentication may be resource intensive. Thus, performing authentication tasks on certain devices may be inefficient, cumbersome, slow, and frustrating to users of the devices.

User may also seek to engage in secure communications such as between clients, between a client and a server and so forth via secure communication channels, such as secure sockets layer (SSL) or transport layer security (TLS). Trust between the parties may be required before a secure session established. In order for one party to trust another party such that secure communications may transpire, a presented certificate is verified. One traditional technique to verify a certificate is to determine that the presented certificate may be traced back to a trusted root certificate installed on a client device which is relying on the certificate for trust. If the root certificate of a particular certificate chain corresponds to a trusted root certificate or other trust anchor installed on the client, then the particular certificate is trusted by the client. This process is referred to as certificate validation and may involve discovering all the possible chains associated with the presented certificate and determining if there is trusted root or issuer certificate in each chain.

However, the traditional certificate validation technique may not work if a corresponding root certificate is not installed locally on a client. Generally, a limited set of root certificates (e.g., implicitly trusted certificates) are installed on a client, such as when initially configured or when operating system software is installed. In some instances, root certificates expire after a period of time. Updated or new root certificates which may be issued are not included on a client and therefore would not be trusted. Users may not be aware that updated or new roots are available which may be installed and/or may not have the technical understanding to install new roots. Further, installing new roots on certain clients, such as mobile clients, may be impractical or impossible. Thus, the traditional certificate chaining technique may cause frustration to users who may be unable to obtain desired services securely as well as to the providers of those services who may miss out on opportunities for subscribers, sales, and so on.

### SUMMARY

Proxy authentication techniques are described in which a proxy service (a.k.a. “delegation service”) acts on a client's behalf to obtain security tokens from an authentication service and store the tokens. In an implementation, a proxy server receives a communication from a client which causes the proxy to act on the client's behalf. Proxy server, in response to the communication, forms a request to an authentication service seeking one or more security tokens. Upon successful authentication, proxy server receives one or more security tokens from the authentication service which are stored on the proxy server on behalf of the client. Then, upon request from the client, proxy presents a security token to permit the client access to corresponding services.

In another implementation indirect certificate chaining techniques are described in which an unknown certificate is verified by tracing the certificate to a known good certificate maintained in a certificate store. In an implementation, an unknown certificate is received by a client from a party seeking to establish trust. The client determines the identity of an issuer certificate corresponding to the received certificate using information contained in the received certificate. Client checks the issuer certificate against a certificate store which maintains a database of known good certificates to determine if the issuer certificate matches a known good certificate.

In an instance, a certificate store may maintain one or more digitally signed data packages each of which may include one or more known good certificates. The digital signature of the data package ensures that the contents of the package have not been altered. Thus, the data package is trusted and accordingly the known good certificates within the package are trusted. Client may establish trust in a certificate and a corresponding party presenting the certificate using the signed data packages maintained in the certificate store, and without using or having a corresponding root certificate installed to the client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment in an exemplary implementation that is operable to provide proxy authentication and indirect certificate chaining.

FIG. 2 is an illustration of a system in an exemplary implementation showing an authentication service, proxy service, and client of FIG. 1 in greater detail.

FIG. 3 is a flow diagram depicting a procedure in an exemplary implementation in which a proxy service acts to obtain and cache one or more security tokens on a client's behalf.

FIG. 4 is a flow diagram depicting a procedure in an exemplary implementation showing interactions of a client, proxy service and authentication service of FIG. 2 involved in obtaining and caching an authentication token at the proxy service.

FIG. 5 is a flow diagram depicting a procedure in an exemplary implementation showing interactions of a client, proxy service and authentication service of FIG. 2 involved in utilizing an authentication token cached at the proxy service to obtain one or more service tokens for storage at the proxy service.

FIG. 6 is an illustration of a system in an exemplary implementation showing a certificate service, service provider, and a client of FIG. 1 in greater detail.

FIG. 7 is a flow diagram depicting a procedure in an exemplary implementation in which a client utilizes a certificate store having one or more signed data packages to verify a certificate.

FIG. 8 is a flow diagram depicting a procedure in which a certificate service provides a plurality of clients access to one or more signed data packages to verify certificates.

The same reference numbers are utilized in instances in the discussion to reference like structures and components.

### DETAILED DESCRIPTION

Overview

Certain clients such as mobile phones, hand held computing devices, and so on may have limited computing power and bandwidth. Accordingly, it may be cumbersome, inefficient, and even impossible to perform resource intensive tasks using certain client devices. For instance, authentication of a client to access protected resources of a service provider may occur very slowly using a device of limited bandwidth. However, such portable devices have become increasingly more popular.

Accordingly, proxy authentication techniques are described in which a proxy service may act on behalf of a client to perform a variety of tasks. For example, a user of cell phone may desire to download ring-tones or an audio file from a service provider configured to provide audio downloads. The service provider may require authentication before access to the desired audio content is provided.

In an implementation, a proxy service is introduced to perform the authentication on behalf of the client to conserve the bandwidth of the client. The user of the cell phone may input user credentials (e.g., username and password) and communicate them to the proxy service. Proxy service forms an authentication request for communication to an authentication service on behalf of the client which contains the credentials. Credentials may be encrypted such that the proxy does not see the credentials in the clear. Authentication service verifies the supplied credentials to authenticate the client.

Upon successful authentication, the proxy receives one or more security tokens which may be used to access corresponding services. The security tokens may include authentication tokens used to prove identity between a client and authentication service, and service tokens used to prove identity at a service provider. In an instance, an authentication token is obtained which may subsequently be used to obtain desired service tokens from the authentication service. In this example, a service token corresponding to the service provider of the desired audio downloads may be issued by the authentication service and received by the proxy service. Rather than return the issued tokens to the client, proxy service stores the tokens on behalf of the client.

Then, upon request by the client, proxy may present a security token on behalf of client to access corresponding services. For instance, the service token corresponding to the service provider of the desired audio downloads may be presented such that the mobile phone is given access to the desired ring-tones or audio files.

A client may also desire to communicate or exchange data securely with another client, a service provider, an authentication service and so forth. Accordingly a secure communications channel, such as secure sockets layers (SSL) or transport layer security (TLS) may be established using certificates as proof of trust. Traditionally, a certificate presented to a client to establish trust is verified by determining if the presented certificate may be traced to a root certificate installed on the client. However, in many cases root certificates on client devices are not maintained or updated because users may not know to update root certificates, may not have the technical understanding to do so, or because it is difficult or impossible to do so using certain clients, such as mobile phone and hand held computing devices. Accordingly, updated or new root certificates which may be issued which are not included on a particular client and therefore would not be trusted. Thus, the traditional certificate verification may cause frustration to users who may be unable to communicate securely as well as to the providers of those services who may not be able to use newer certificates as a basis for trust.

Accordingly, indirect certificate chaining techniques are described in which certificates may be verified without using or having corresponding root certificates installed to a client device. For example, a user of a client device configured as a handheld computing device may seek to use an application such as an instant messaging application or web browser to securely exchange data with another party. In this example, assume the client is communicating purchasing information to a service provider who is an online merchant. The online merchant may provide a certificate as proof of trust to establish a secure session. The client is configured to extract information from the presented certificate to identify an issuer certificate corresponding to the presented certificate.

Rather than compare the issuer certificate to a root certificate on the client, the client uses the extracted information to determine if the identified issuer certificate matches a trusted issuer certificate maintained in a certificate store. In an implementation, a certificate service maintains a certificate store accessible to a plurality of clients via a network. The certificate store has at least one signed data package containing one or more know good certificates, against which the identified issuer certificate may be checked. If a match is found, then the received certificate and accordingly the online merchant of the present example will be trusted, and the secure session may be established.

Exemplary Environment

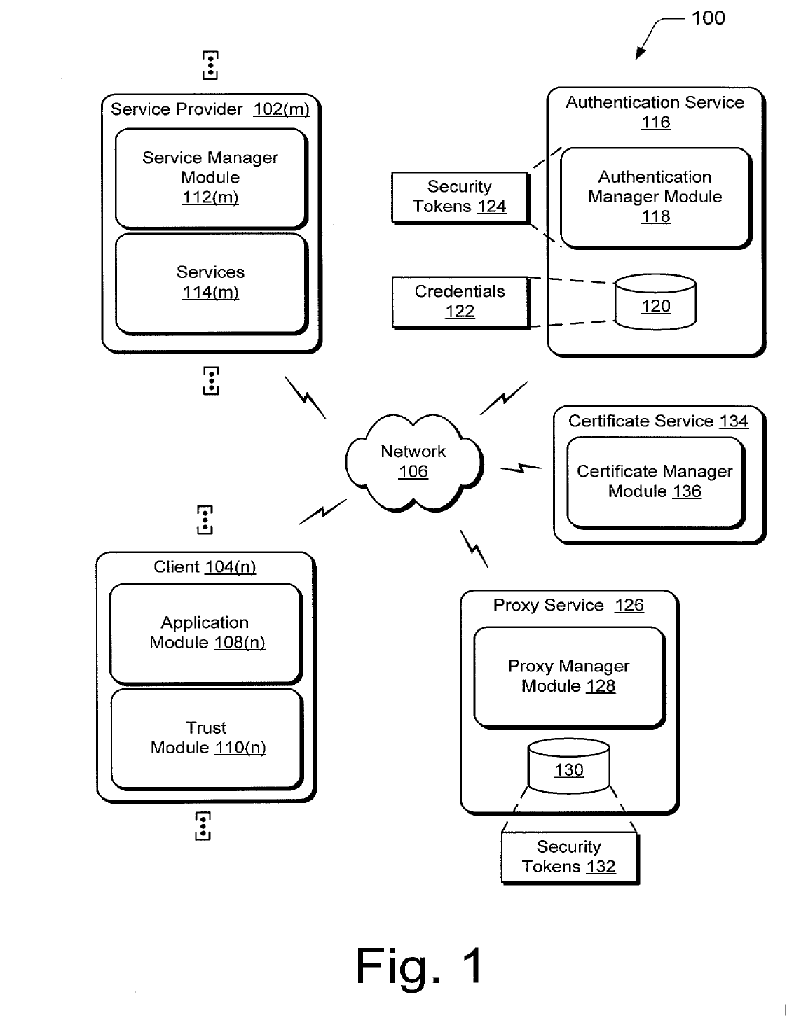

FIG. 1 is an illustration of an environment 100 in an exemplary implementation that is operable to employ proxy authentication and indirect certificate chaining techniques. The illustrated environment 100 includes a plurality of service provider 102(m) (where “m” can be any integer from one to “M”) and a plurality of clients 104(n) (where “n” can be any integer from one to “N”) that are communicatively coupled over a network 106.

Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks.

The clients 104(n) may be configured in a variety of ways for accessing the service providers 102(m). For example, one or more of the clients 104(n) may be configured as a computing device, such as a desktop computer, a mobile station, an entertainment appliance, a set-top box communicatively coupled to a display device, a wireless phone, a game console, and so forth. Thus, the clients 104(n) may range from full resource devices with substantial memory and processor resources (e.g., personal computers, game consoles) to low-resource devices with limited memory, processing and/or display resources (e.g., traditional set-top boxes, hand-held game consoles, mobile multimedia devices, wireless phones and so forth). For purposes of the following discussion, the clients 104(n) may also relate to a person and/or entity that operate the clients. In other words, one or more of the clients 104(n) may describe logical clients that include users, software, and/or devices.

Each of the plurality of clients 104(n) is depicted having a respective one of a plurality of application modules 108(n). Naturally each of clients 104(n) may execute a plurality of application modules 108(n) configured in a variety of ways. Application modules 108(n) are executable to provide a variety of functionality to respective clients 104(n). For example, one or more of application modules 108(n) may be configured to send and receive email. Email employs standards and conventions for addressing and routing such that the email may be delivered across the network 106 utilizing a plurality of devices, such as routers, other computing devices (e.g., email servers), and so on. In another example, application modules 108(n) may be configured to provide one or more business productivity functions such as word processing, database, spreadsheet, and presentation functionality. In a further example, application modules 108(n) may be configured to provide one or more software development functions such as development interfaces, tools, management, and compilation. Further, one or more application module 108(n) may provide other computing functions such as graphic design, web browsing, and media management, editing, viewing, and/or playback.

In yet another example, one or more of application modules 108(n) may be configured to send and receive instant messages. Instant messaging provides a mechanism such that a plurality of clients 104(n), when participating in an instant messaging session, may send text messages to each other. A plurality of clients 104(n) may be configured to communicate one to another via network 106. The instant messages are typically communicated in real time, although delayed delivery may also be utilized, such as by logging the text messages when one of the clients 104(n) is unavailable, e.g., offline. Thus, instant messaging may be thought of as a combination of e-mail and Internet chat in that instant messaging supports message exchange and is designed for two-way live chats. Therefore, instant messaging may be utilized for synchronous communication. For instance, like a voice telephone call, an instant messaging session may be performed in real-time such that each user may respond to each other user as the instant messages are received.

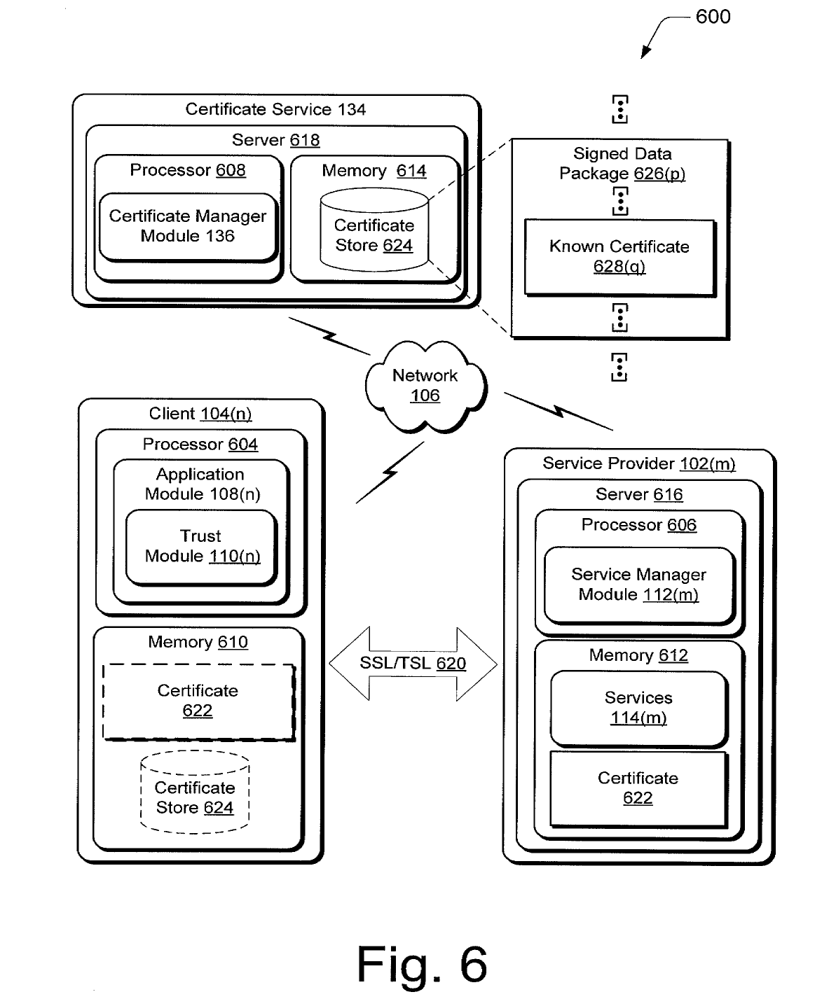

Clients 104(n) further are depicted as each having a respective trust module 110(n) which represents functionality to enable secure communications between a client 104(n) and another party, such as between two of clients 104(n), between a client 104(n) and one of services provider 102(m), and so forth. More particularly trust module 110(n) may be configured to establish trustworthiness of another party based on proof (e.g., a certificate) presented to the client 104(n) by the party, further discussion of which may be found in relation to FIGS. 6-8.

The service providers 102(m) are illustrated as each having a service manger module 112(m) and each may provide a plurality of services 114(m) that are accessible to clients 104(n) via the network 106. Service manger module 112(m) represents functionality that may manage services 114(m), access to services 114(m) over network 106, communication with clients 104(n) seeking services 114(m), and so forth. Although illustrated separately, the functionality represented by the service manager module 112(m) may be incorporated within the services 114(m) themselves.

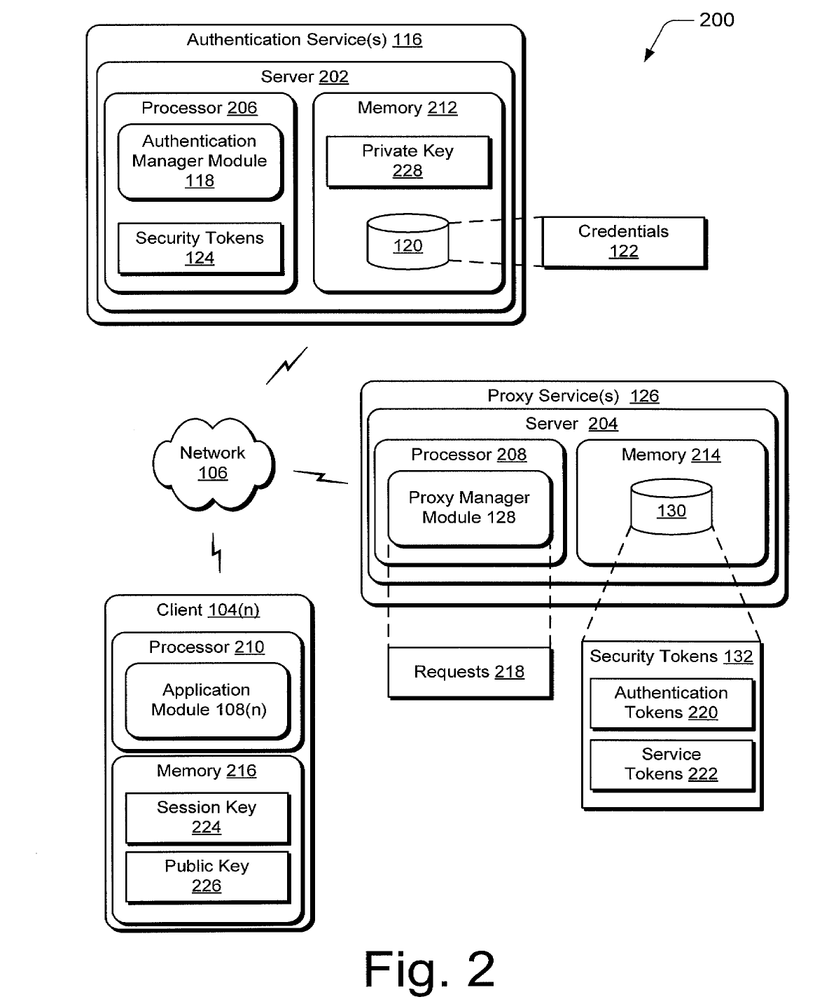

The services 114(m) may be configured in a variety of ways to provide functionality over the network 106 to the clients 104(n). For example, the services 114(m) may be configured for access via platform-independent protocols and standards to exchange data over the network 106. The services 114(m), for instance, may be provided via an Internet-hosted module that is accessed via standardized network protocols, such as a simple object access protocol (SOAP) over hypertext transfer protocol (HTTP), extensible markup language (XML), and so on, further discussion of which may be found in relation to FIG. 2.

A variety of functionality may be made available via the plurality of services 114(m). For example, a web search service (e.g., a search engine) may be provided to search the Internet, an email service may be provided to send and receive email, and an instant messaging service may be provided to provide instant messaging between the clients 104(n). Additional examples include a news service, a shopping (e.g., “ecommerce”) service, and a web log service. Further, productivity services may also be provided, such as word processing, spreadsheets, presentations, drawings, note-taking, and so on. For instance, network access may be given to the client 104(n) to applications that were traditionally executed locally on the client 104(n) itself. Therefore, execution of the applications may be performed remotely at the one of service providers 102(m) and results of the execution may be communicated over the network 106 to the clients 104(n). Although a few examples of services 114(m) have been described, it should be apparent that a wide variety of other services 114(m) are also contemplated.

Certain service providers 102(m) and/or services 114(m) may require authentication of clients 104(n) (e.g., proof of identity) before access is permitted. In an implementation, one or more of service providers 102(m) may be configured to redirect clients 104(n) seeking access to services 114(m) to authentication service 116 for authentication.

Thus, rather than authenticate directly with the service providers 102(m), an authentication service 116 may be executed to authenticate clients 104(n), thereby “offloading” authentication to the authentication service 116. In this way, the service provider 102(m) may be configured to understand whether the clients 104(n) were successfully authenticated by the authentication service 116, but need not “understand” how the authentication was performed. Authentication via a service may be limited to a particular one of service providers 102(m), such that authentication would be valid only for the particular one of service providers 102(m). Alternatively, a single authentication with an authentication service may permit access to services 114(m) of a plurality of service providers 102(m). In other words, a single verification of credentials (i.e., sign-in) to the authentication service 116, may authenticate the client (i.e., provides proof of identity of the client) for access to a plurality of service providers 102(m).

Authentication service 116 is depicted as having an authentication manager module 118 and storage 120 which may be configured to store a variety of credentials 122. Authentication manager module 118 is representative of functionality which may be utilized to authenticate a client 104(n), which includes but is not limited to: receiving authentication requests, verification of client credentials 122, generating responses and so forth. Authentication service 116 is also depicted as storing in storage 120 a plurality of client credentials 122 which may correspond to respective clients 104(n). Client credentials 122 may be used to verify that the clients 104(n) “are who they say they are” or in other words authenticate the client's identity. The client credentials 122, for example, may be user names and passwords corresponding to clients 104(n). Other client credentials 122 are also contemplated such as a shared secret, an encryption key and so forth. In general, authentication service 116 operates to authenticate clients 104(n) by comparing credential information (e.g., name and password) provided by the client 104(n) with client credentials 122 accessible to authentication service 116 (e.g., stored in within storage 120).

Upon successful authentication, authentication service 116 may be configured to generate and/or issue security tokens 124. Security tokens 124 are configured to be used between clients 104(n) and service providers 102(m) to prove the identity of the clients 104(n) in order to access respective services 114(m). Naturally, authentication service 116 may be thought of as a service provider providing authentication service and may issue security tokens 124 which are configured to be used between clients 104(n) and the authentication service 116 itself. Further discussion of various security tokens 124 generated by authentication service 116 may be found in relation to FIG. 2.

In one traditionally technique, authentication occurs directly between a client and a server, e.g. directly between clients 104(n) and authentication service 116 or even directly between clients 104(n) and service providers 102(m). However, transactions involved in direct authentication of clients 104(n) may be computationally expensive. For instance, secure communications sessions such as secure sockets layer (SSL) or transport layer security (TLS) may be established in the process of authentication, a variety of transactions may occur, bandwidth consumed and so forth. Accordingly, is may be desirable to offload certain tasks to conserve resources of clients 104(n), to enhance performance, to streamline authentication for numerous clients 104(n), to increase efficiency and so forth. Offloading of certain tasks may be particularly beneficial to certain clients 104(n) such as mobile phones, laptops, handheld computing devices, audio players and so forth which may have insufficient processing, storage, battery power and so forth to make direct authentication suitable, efficient, or even possible.

Accordingly a proxy service 126 is introduced to perform a variety of tasks on behalf of clients 104(n) thereby saving bandwidth of the clients 104(n). Proxy server 126 may be configured to act as an intermediary between the clients 104(n) and an authentication service 116, as well as between clients 104(n) and service providers 102(m).

In one or more implementations resource intensive tasks involved in authentication of clients 104(n) may be “off-loaded” from clients 104(n) to a proxy service 126. While only one proxy 126 is depicted in FIG. 1 it is contemplated that the plurality of clients 104(n) may interact with a variety of different proxy services 126.

Proxy service 126 is depicted having a proxy manager module 128 and storage 130 which may be configured to store a plurality of security tokens 132 on behalf of clients 104(n). Proxy manager module 128 is representative of functionality which may be executed to perform a variety of tasks including but not limited to forming authentication requests, receiving and storing security tokens, and presenting security tokens on behalf of clients 104(n). Thus, proxy service 126 may be configured to communicate with authentication service 116 and service providers 102(m) on behalf of a plurality of clients.

More particularly, proxy service 126 may be configured to request, receive, store, and manage security tokens 124 generated by authentication service 116 upon authentication of clients 104(n), such that clients 104(n) may access services 114(m) without direct authentication and without ever physically receiving security tokens 124. Storage 130 of proxy service 126 is depicted having a plurality of security tokens 132 which represent a portion of security tokens 124 generated by authentication service(s) 116 which are stored by a particular proxy service 126 on behalf of clients 104(n). Proxy service 126 may further be configured to present the appropriate security tokens 132 on behalf of clients 104(n) such that the clients 104(n) may access corresponding services 114(m). Thus, proxy service 126 of FIG. 1 may perform a variety of tasks on behalf of clients 104(n) further discussion of which may be found in relation to FIG. 2.

Clients 104(n) may further be communicatively couple via network 106 to a certificate service 134 depicted in FIG. 1 as having a certificate manager module 136. Certificate manager module 136 is representative of functionality be utilized for verification of certificates which may include but is not limited to managing interaction of certificate authority 134 with clients 104(n), maintaining a plurality of known certificates, and providing information to clients 104(n) enabling them to verify certificates presented by other parties to establish trust. In an implementation, respective trust modules 110(n) of clients 104(n) are configured to verify certificates via a certificate store which may be maintained by certificate authority 134, further discussion of which may be found in relation to FIGS. 6-8.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the proxy authentication techniques and indirect certificate chaining described below are platform-independent, meaning that the techniques may be implemented on a variety of commercial computing platforms having a variety of processors.

FIG. 2 is an illustration of a system 200 in an exemplary implementation showing the authentication service 116, proxy service 126 and a client 104(n) in greater detail. In FIG. 2, the proxy service 126 and authentication service 116 are illustrated as being implemented by respective servers 202, 204 and the client 104(n) is illustrated as a client device. While a single server 202, 204 is shown for each of the authentication service 116 and proxy service 126 respectively, it is contemplated that each service may be implemented by a plurality of servers, e.g. a server farm.

The servers 202, 204 corresponding to authentication service 116 and proxy service 126, and the client 104(n) each include a respective processor 206, 208, 210 and respective memory 212, 214, 216. Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 212, 214, 216 is shown, respectively, for the servers 202, 204 and the client 104(n), a wide variety of types and combinations of memory may be employed, such as random access memory (RAM), hard disk memory, removable medium memory, and so forth.

Client 104(n) may execute an application module 108(n) to access services 114(m) of one or more of service providers 102(m) depicted in FIG. 1. For instance, application module 108(n) may be configured to provide instant messaging as previously described. The application module 108(n) may be executable on processor 210 as depicted in FIG. 2 and is storable in memory 216 of client 104(n). Application module 108(n) may be configured to access instant messaging service from one of service providers 102(m) in order to provide instant functionality messaging to client 104(n). Client 104(n) may need to be authenticated prior to accessing the desired instant messaging service from the service provider 102(m), for instance via authentication service 116.

In accordance with the principles of the present disclosure, proxy service 126 may operate to perform tasks on behalf of the client 104(n), such that client 104(n) may access the desired services 114(m), for instance the instant messaging service of the previous example. In FIG. 2, proxy service 126 is illustrated having proxy manager module 128 being executed on processor 208 and which is storable in memory 214 of the server 204. As previously described, the proxy manager module 128 is representative of functionality that may be executed to act on behalf of a client 104(n), for instance as an intermediary between the client 104(n) and authentication service 116. In particular, proxy manager module 128 is depicted as generating a plurality of requests 218. Requests 218 may include a plurality of requests made by the proxy service 126 on behalf of a variety of clients 104(n), such as authentication requests, service requests, and so on. Requests 218 may be configured to include a variety of information received from the client 104(n), such as user credentials (e.g., username and password), services desired, and so forth. The requests 218 may be communicated via network 106 to authentication service 116 in order to obtain security tokens 132, which are depicted as being stored on behalf of client within memory 214 of the proxy service 126.

Authentication manager module 118 is depicted as executed on processor 206 and is storable in memory 212 of server 202. Authentication manager module 118 may be configured to receive and process requests 218 from proxy server 126. As previously described authentication service 116 is operable to authenticate the client 104(n) using stored credentials 122. For instance, the client 104(n) may provide a username and password to the proxy service 126 which are included in a request 218 made on the client's 104(n) behalf. Authentication manager module 118 authenticates the client 104(n) using the credentials 122 depicted in FIG. 2 as stored in storage 120 within memory 212 of server 202.

When the authentication is successful (i.e., the client 104(n) “is who they say they are”), the authentication manager module 118 may issue one or more security token 124 corresponding to the client 104(n) that are configured to be used as proof of identity by the client 104(n). For instance, respective security tokens 124 may be used to as proof of identity in future transactions with the authentication service 116 and/or to access services 114(m) of corresponding service providers 102(m) of FIG. 1. In this manner that client 104(n) is not forced to re-authenticate (e.g., provide credentials) each time services 114(m) are desired or in each dealing with authentication service 116. Naturally, security tokens 124 may be issued by a single authentication service for a plurality of clients 104(n).

In an implementation, security tokens 124 are configured to expire after some period of time or upon occurrence of certain events, such as the end of a session, the closing of an application 108(n), and so forth. Thus, security tokens 124 will have an associated time period during which the security token is valid proof of identity and after which the token will not be valid. Upon expiration of a particular security token 124, client 104(n) may re-authenticate to refresh the security token 124 or obtain new security tokens 124.

Authentication manager module 118 may further be configured to communicate some or all issued security tokens 124 to the proxy service 126. For instance, authentication manager module 118 may generate a response to a request 218 having one or more issued security tokens 124 corresponding to client 104(n). Proxy service 126 is configured to store and manage tokens 124 issued to client 104(n). In particular, a plurality of security tokens 132 are depicted as stored within memory 214 of proxy service 126. Security tokens 132 represent a portion of security tokens 124 issued by one or more authentication service 116 which are stored on behalf of clients at a particular proxy service 126.

Security tokens 124, 132 are configured as data or objects which may be used to prove an assertion such as the identity of client 104(n). Security tokens 124, 132 may be configured in a variety of ways, such as a public key, a shared secret, a binary large object, and or other forms of data which may be utilized to prove identity of a client 104(n) to access respective services of a service provider 102(m) and/or authentication service 116.

Security tokens 132 are depicted in FIG. 2 as including both authentication tokens 220 and service tokens 222. It is noted that security tokens 124 may also include both authentication tokens 220 and service tokens 222. Generally, an authentication token 220 is used in transactions between the client 104(n) and authentication service 116 to prove identity of the client 104(m). A service token 222 corresponds to a service provider 110(m) and/or particular services 114(m) of a service provider 102(m) and accordingly is used between the client 104(n) and service provider 102(m) to prove identity of the client 104(n).

As previously indicated, client 104(n) may provide a variety of information which is communicated to the proxy service 126 to be used in performing tasks on behalf of the client, such as forming requests 218. However, information provided for authentication may involve sensitive information (e.g., user credentials, account data, personal identifying information) which if sent in the clear to the proxy service 126 may pose a security threat to users.

In an implementation, proxy service 126 receives and uses information provided by clients 104(n) on the client's behalf but is not able to read the provided information. Proxy service 126 may understand when, where, and how to direct data when prompted, but may not necessarily understand the data itself. For instance, a variety of encryption techniques such as shared secret, key pairs, and so forth, may be employed to prevent the proxy service 126 from reading certain data, such as certain information provided by client 104(n) and/or the stored security tokens 132. Thus, proxy service 126 may be configured to format and route communications and/or data between a client 104(n), authentication service 116, and service providers 102(m) as well as to store and manage security tokens 132, but may not be able to understand the security tokens or portions of the communications.

Client 104(n) is depicted having representative encryption keys which may be used in one or more encryption techniques. A session key 224 and a public key 226 are depicted within memory 216. Public key 226 may correspond to a private key 228 which is depicted as stored in memory 212 of authentication service 116. Using these and/or other encryption keys and techniques, portions of the communications and data may be encrypted, such that proxy service 126 is unable to read the encrypted portions, further discussion of which may be found in relation to the following procedures.

Exemplary Procedures

The following discussion describes proxy authentication techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 200 of FIG. 2.

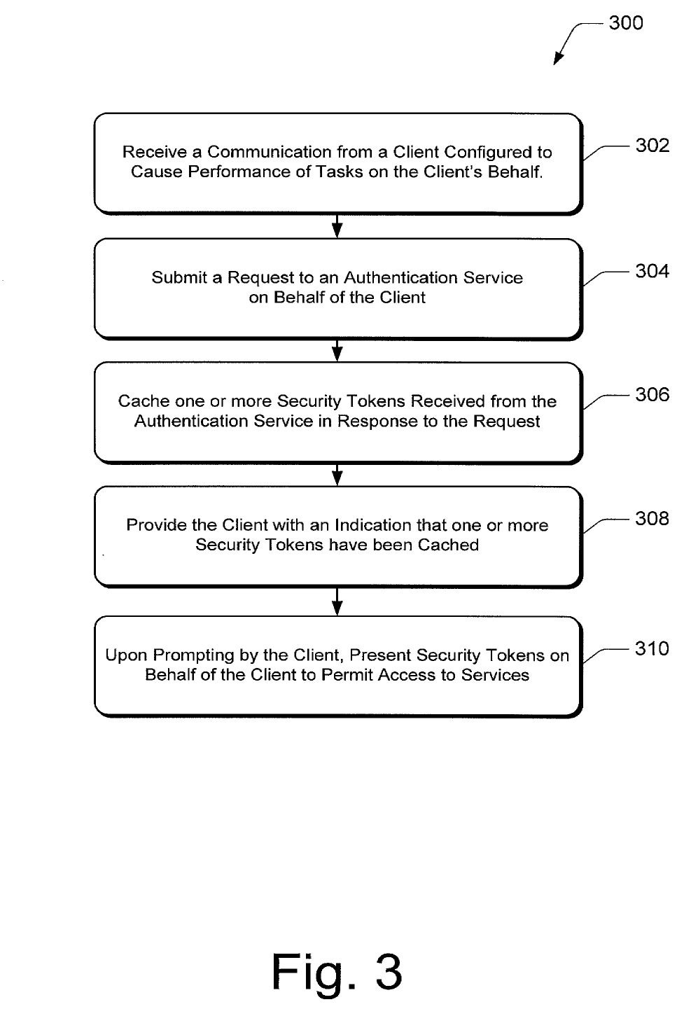

FIG. 3 depicts a procedure 300 in an exemplary implementation in which a proxy service acts on behalf of a client to request, receive and store security tokens on behalf of a client. A communication is received from a client configured to cause performance of tasks on the client's behalf (block 302). For example, a client 104(n) of FIG. 2 may be seeking access to services 114(m) of a service provider, such as access to email service of a service provider 102(m). In one instance, client 104(n) may be a limited resource device, such as a handheld computing device, a mobile phone and so forth. Accordingly, it may be inconvenient or impossible to use the client 104(n) to directly perform authentication tasks and/or manage security tokens to access the desired email service. Client 104(n) may be configured to communicate with a proxy service 126 to cause performance of tasks (e.g., authentication and security tokens management) on the client's 104(n) behalf.

A request is submitted to an authentication service on behalf of the client (block 304). In response to the received communication from the client 104(n), proxy service 126 may form a request 218 as depicted in FIG. 2. In one instance, the request 218 may include an authentication request, which provides user credentials (e.g., username and password supplied by the client 104(n)) for verification by the authentication service 116. An authentication token 220 may be issued by authentication service 116 in response to such a request 218. In another instance, the request 218 may be configured to seek additional security tokens 124 using a previously obtained authentication token 220, e.g., to obtain a service token 222 corresponding to the desired email service. Generally a request 218 is configured to seek one or more security tokens 124. A variety of security tokens 124 and/or other data may be sought in combination in a single request 218, such as a request 218 for multiple security tokens, for both authentication 220 and service 222 tokens, for a token and a certificate, and so forth.

Authentication service 116 processes the submitted request 218 and upon successful authentication may be configured to issue one or more security tokens 124, which are communicated to the proxy service 126. In the previous example authentication service may verify supplied credentials to authenticate the client 104(n) and issue an authentication token 220 corresponding to client 104(n) in response to the request 218. In response to the same or a subsequent request, a service token 222 corresponding to the desired service 114(m) (e.g., email service) and/or service provider may be issued.

One or more security tokens received from the authentication service in response to the request are cached (block 306). For instance, proxy service 126 may receive and store security tokens 132 within storage 130 of memory 214 as depicted in FIG. 2.

An indication is provided to the client that the one or more security tokens have been cached (block 308). In an implementation, proxy service 126 maintains security tokens 132 on behalf of the client 104(n). Proxy service 126 communicates with client such that the client 104(n) understands that the proxy service is maintaining tokens 132 on behalf of the client 104(n), however the client 104(n) does not physically receive the tokens. Thus, in the previous example, proxy service 126 may provide a responsive message to the client 104(n) indicating that appropriate security tokens 132 for accessing desired email service are cached. Naturally, the indication provided by the proxy service could be provided in a variety of ways, such as proxy generating a response, forwarding a response from the authentication service 116, via a single response for multiple tokens, via a plurality of messages, via a variety of communication modes and so forth.

Upon request of the client, security tokens are presented on behalf of the client to permit access to services (block 310). For example, the client 104(n) may attempt to access the desired email service directly from service provider 102(m) or through the proxy service 126. In either case, the proxy service 126 operates to present security tokens 132 on behalf of the client 104(n). For instance, a service token 222 corresponding to the desired email service and/or service provider 102(m) may be presented for verification by the service provider 102(m), such that the client 104(n) is given access to the service. The presenting may involve actually communicating the service token 222 to service provider 102(m) or communications between the proxy service 126 and service provider 102(m) such that service provider 102(m) understands that the proxy service 126 is presenting the appropriate service token 222 on behalf of client 104, and that the token is valid. Upon verification of the presented service token 222, client 104(n) is permitted access to desired email service.

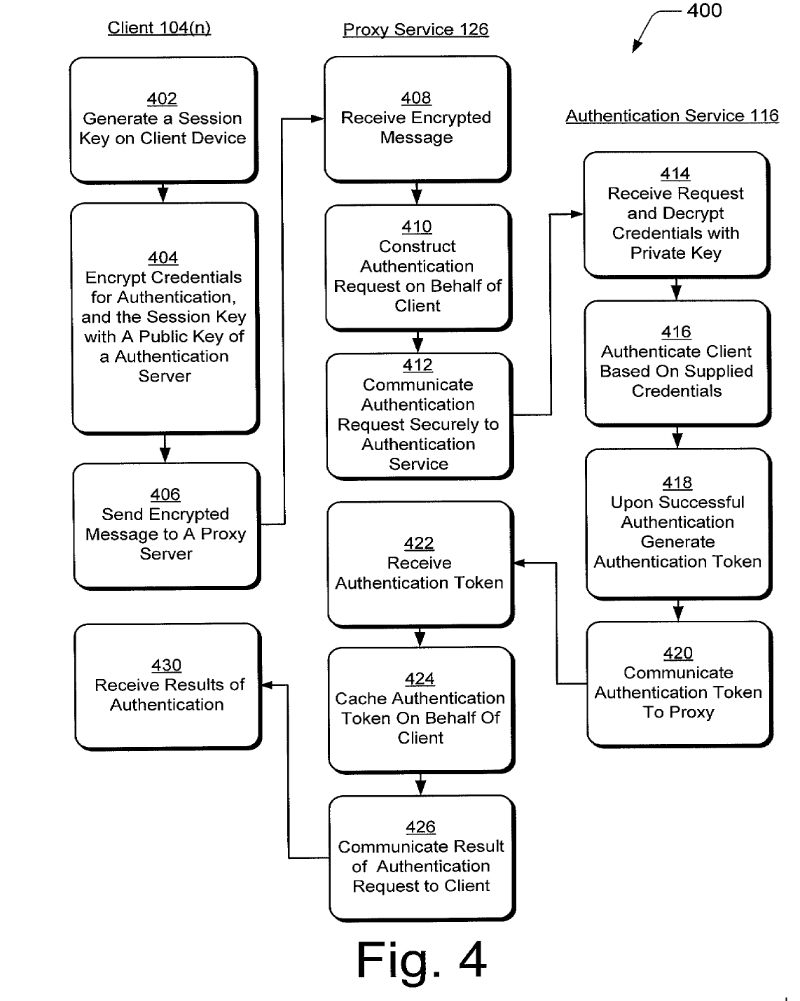

FIG. 4 depicts a procedure 400 in an exemplary implementation in which a proxy service is utilized to obtain and store an authentication token on behalf of a client. The blocks are arranged in columns each representing one of the components depicted in the system of FIG. 2 (e.g., the client 104(n), proxy service 126, and authentication service 116) and showing exemplary interactions between the components.

Client 104(n) may desire to sign-on to an authentication service 116. Client generates a session key for communication to the authentication service (block 402). For example, client 104(n) of FIG. 2 may generate the session key 224 depicted in memory 216 of the client 104(n). The session key and user credentials are encrypted using a public key corresponding to the authentication service (block 404) and sent in a message to the proxy server (block 406). For instance, a user of client 104(n) may input a username and password to sign-in to the authentication service 116. The username and password are encrypted along with the session key 224 using the public key 226 of the authentication service and are sent to proxy service 126. The message sent to the proxy service is configured to cause the proxy server to perform tasks on behalf of the client. In the particular example, the message may indicate to the proxy server that an authentication request should be formed.

The proxy service receives the encrypted message (block 408) and in response constructs an authentication request on behalf of the client (block 410). The request includes the encrypted information provided by the client 104(n).

The authentication request is communicated securely to the authentication service (block 412). For instance, proxy service 126 may be configured to establish secure communications with the authentication service such as via SSL, TLS or other secure channel communications. Again, it is noted that such secure transaction may be resource intensive. Proxy service 126 having relatively greater capabilities (e.g., bandwidth, computing power, connection speed, and so forth) than client 104(n), performs tasks for the client 104(n) thereby conserving resources of the client 104(n) and increasing efficiency of the process.

The authentication service 116 receives the request and uses a private key corresponding to the public key to decrypt the information from the client included in the request (block 414). For instance private key 228 may be use to obtain the username and password, and session key 224 from the received request.

The client is authenticated based on the supplied credential information (block 416). For instance, supplied credentials may be checked against credentials 122 maintained by the authentication service 116 in a credential store 120 to authenticate client 104(n).

Upon successful authentication, an authentication token is generated (block 418). For instance an authentication 220 may be generated by authentication service 116. In one or more implementation, authentication tokens 220 may be used to obtain service tokens 222 corresponding to a plurality of service providers. In an instance, the generated authentication token 220 may be a limited discretionary access token (LDAT). The LDAT is configured to contain information which may limit the services 114(m) or service providers 102(m) for which service tokens may be obtained. A variety of different limits are contemplated for an LDAT such as limits based on type of client device, the type of services, a subscription level of a client, time limits and so forth. For example, an LDAT may be issued for a mobile phone which is limited to being used with services 114(m) which are appropriate for the particular phone, such as being properly formatted, or to services 114(m) which the client has subscribed. In other words, certain services 114(m) which may not be suitable for the phone may be restricted using the LDAT.

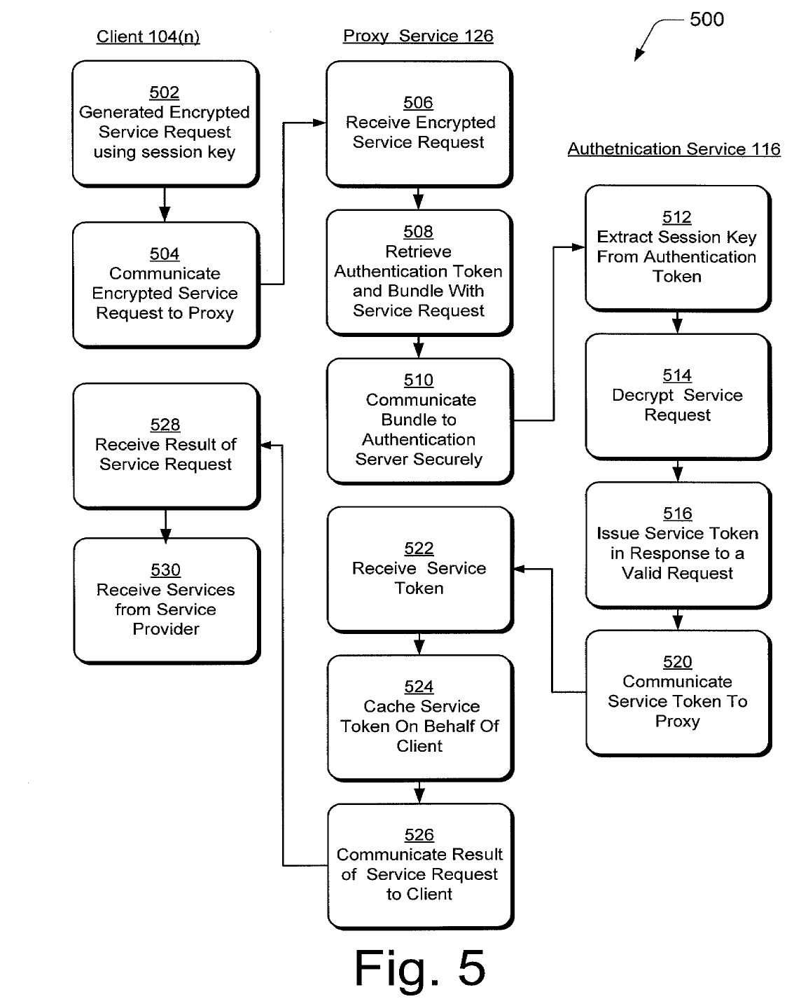

Further, the LDAT is configured to contain the session key 224 provided by the client 104(n) to the authentication service 116 via the proxy service 126. The session key 224 may be used to enable decryption of encrypted service requests at the authentication service 126 further discussion of which may be found in relation to FIG. 5.

The generated authentication token 222 is communicated to the proxy service 126 (block 420) which receives the authentication token (block 422). The proxy service 126 caches the authentication token on behalf of the client (block 424). Again, a proxy server 126 may store a plurality of security tokens 132 corresponding to a plurality of clients 104(n) in memory 214 to be used on behalf of respective clients 104(n) to access a variety of services 114(m).

Upon caching the security tokens, proxy service 126 provides the client 104(n) with an indication of the results (block 436). In the depicted instance authentication was successful and accordingly proxy service 126 communicates that an authentication token 220 has been stored. In other cases, authentication may be unsuccessful and no authentication token 220 will be issued. In these cases, proxy service 126 may communicate that authentication was unsuccessful. Client 104(n) receives the communicated results (block 430). Subsequent to the caching of authentication token 220 on proxy service 126, the authentication token 220 may be used on behalf of the client 104(n) as proof of identity at the authentication service 116, further discussion of which may be found in relation to the following discussion of FIG. 5.

FIG. 5 depicts a procedure 500 in an exemplary implementation in which an authentication token maintained at proxy service is utilized to obtain and store service tokens on behalf of a client. Again, the blocks are arranged in columns each representing one of the client 104(n), proxy service 126, and authentication service 116 in the system of FIG. 2 and showing exemplary interactions thereof. While particular interactions are described it should be appreciated that a variety of other arrangements in which a proxy service acts on behalf of a client may be utilized without departing from the spirit and scope of the principles described herein.

A client generates an encrypted service request using a session key (block 502). Assume client 104(n) of FIG. 2 has been authenticated via the procedure described in FIG. 4. Proxy server 126 is storing an authentication token 220 corresponding to client 104(n).

Client 104(n) may desire to access services 114(m) from one or more service provider 102(m). For example, client 104(n) may be executing an application module 108(n) configured as a web browser and desires services 114(m) in the form of multimedia content from a particular service provider 102(m). Client 104(n) is configured to generate a service request, seeking a service token 222 corresponding to the desired multimedia content and/or service provider. As previously described, authentication token 220 may be configured as an LDAT containing a session key 224. Thus the same session key 224, previously generated by the client 104(n) may be used to encrypt the service request.

The encrypted service request is communicated to the proxy service (block 504) and the proxy service receives the request (block 506). Upon receipt of the service request proxy service 126 is configured to perform task on the client's 104(n) behalf. In particular, the proxy service 126 retrieves the stored authentication token 220 corresponding to the client 104(n) and bundles the authentication token 220 and encrypted request for communication to the authentication service 116 (block 508). It is noted, that proxy service 126 routes the service request, but may not be able to read the encrypted request. Thus security and privacy of the client 104(n) may be increased.

The bundle is then communicated to the authentication service securely (block 510). Again secure communications such as SSL/TLS may be utilized.

The authentication service 116 extracts the session key included in the authentication token (block 512) and uses the session key to decrypt the service request (block 514). For example, authentication service 116 may execute authentication manager module 118 to extract the session key 224 from an authentication token 220 configured as an LDAT and use the session key 224 to decrypt the received request. Authentication manager module 118 may be further configured to determine the validity of the service request, for instance determining if the limits of the LDAT allow issuance of a service token 222 corresponding to desired multi-media content for the web-browser, that the authentication token 220 is valid, and so forth.

In response to a valid request, authentication service issues a service token (block 516) which is communicated to the proxy service (block 520) for storage on behalf of the client. Proxy service 126 receives the issued service token (block 522) and caches the service token on behalf of the client (block 524). Proxy service communicates the result of the service request to the client (block 526) and the client 104(n) receives the results (block 528). In the depicted instance a service token 222 has been issued and proxy service 126 accordingly communicates to client 104(n) that the service token 222 has been cached. In other instances, service request may be unsuccessful, such as if limits in a LDAT prevent access, and the proxy service 126 will communicate that the request was unsuccessful.

Thereafter, the client 104(n) may receive services from the service provider (block 530). For instance, the client 104(n) may receive the desired multimedia content in the preceding example, upon verification of the service token 222 by the service provider 102(m). As previously described in relation to FIG. 3, proxy server 126 may present the service token 222 to the service provider 102(m). This may be a physical transfer of the token or communication sufficient for the service provider 102(m) to understand that the appropriate service token 222 has been presented. Service provider 102(m) then provides the desired services 114(m) to the client 104(n) either directly or via the proxy service 126.

Indirect Certificate Chaining

Establishing secure communications may require certificate exchange between parties. In order for one party to trust another party such that secure communications may transpire, a presented certificate is verified. One traditional technique to verify a certificate is to determine that the presented certificate may be traced back to a trusted root certificate pre-installed on a client device relying on the certificate for trust. A root certificate may be used to issue a variety of certificates which in turn may each be used to issue additional certificates and so on, thereby forming a certificate chain between a particular certificate and a root certificate. A particular certificate may contain information for determining the root certificate under which the particular certificate was issued. If the determined root certificate corresponds to a trusted root certificate installed on the client, then the particular certificate is trusted by the client. This process is referred to as certificate chaining.

However, the traditional certificate chaining technique may not work if the client does not have a corresponding root certificate installed locally. Generally, a limited set of root certificates are installed on a client, such as when initially configured or when operating system software is installed. In some instances root certificate expire after a period of time. Updated or new root certificates which may be issued are not included on a client and therefore would not be trusted. Users may not be aware that updated or new roots are available which may be installed and/or may not have the technical understanding to install new roots. Further, installing new roots on certain clients, such as mobile clients, may be impractical or impossible. The traditional certificate chaining technique may cause frustration to users who may be unable to obtain desired services securely as well as to the providers of those services who may miss out on opportunities for subscribers, sales, and so on.

Accordingly, indirect certificate chaining techniques are described in which a signed data package having a plurality of known good certificates is used to verify a certificate and establish trust in the presenter of the certificate. The signed data package is readily updateable and does not require root certificates to be installed on clients.

FIG. 6 is an illustration of a system 600 in an exemplary implementation showing a certificate service, a client and service provider of FIG. 1 in greater detail. System 600 is operable for performing indirect chaining techniques described herein.

The client 104(n), service provider 102(m) and certificate service 134 are depicted as having respective processors 604, 606, 608. In addition, each has a respective memory 610, 612, 614. Service provider 102(m) and certificate service 134 are depicted as being implemented by respective servers 616, 618. While a single server is depicted for service provider 102(m) and certificate service 134, each may be implemented by a plurality of servers, e.g. a server farm.

Clients 104(n) is depicted as executing an application module 108(n) on processor 604 which may be configured to provide a variety of functionality to client 104(n) as previously described with respect to FIG. 1, such as to provide email, productivity functions, instant messaging, and so forth.

In an implementation, application module 108(n) is further configured to include functionality to create secure transactions between clients using secure channel protocols (Schannel). Schannel implements secure sockets layer (SSL) and transport layer security (TLS) collectively, which is referred to as “SSL/TLS”. SSL/TLS authenticates and secures data transactions using certificates and encryption. SSL/TLS, for instance, may utilize symmetric and/or asymmetric key encryption based upon public keys provided in certificates. Using these or other protocols, a secure communications channel (e.g., a SSL/TLS session) is established between parties (e.g., client-server, client-client) by certificate exchange. Certificate exchange may be unilateral or bilateral. In FIG. 6, application module 108(n) is depicted as incorporating a trust module 110(n) which represents functionality to verify certificates presented to a client 104(n) using indirect chaining techniques.

A variety of secure transactions may occur between parties over a secure channel such as communications, purchases, account access, data exchange such as sharing of photos, files, applications and so forth. A representative SSL/TLS session 620 between client 104(n) and service provider 102(m) is depicted in FIG. 6 by the double headed arrow. Naturally, a client 104(n) may establish SSL/TLS sessions 620 with a variety of other parties, such as with a plurality of service providers, with authentication service 116 or proxy service 126 of FIG. 1, and so forth.

Service provider 102(m) is depicted as executing a service manager module 112(m) on processor 606, which as previously described may manage interaction with clients, access to services 114(m), performance of services 114(m) and so on. A plurality of services 114(m) and a certificate 622 configured to be used for establishing trust are depicted a storable within memory 612 of the service provider 102(m). In one or more instance, a client 104(n) may desire secure access to services 114(m). To establish a secure SSL/TLS session 620 with a client 104(n), service provider 102(m) may provide a certificate 622 such that the client 104(n) may determine if the service provider is trustworthy. For instance, service manager module 112(m) may be executed to present the certificate 622 to client 104(n) in order to establish SSL/TLS session 620.

A certificate is a digital form of identification that is traditionally issued by a certificate authority (CA) and may contain identification information, a validity period, a public key, a serial number and the digital signature of the issuer. The certificate binds the identity of the entity to whom the certificate was issued to the public key. Security support protocols such as Schannel may then be used to create secure sessions between clients and server or between clients. Certificates may be configured in a variety of ways, such as traditional certificates, third party certificates, signed or unsigned, International Telecommunication Union (ITU) Recommendation x.509, and so forth.

In accordance with the principles of the present disclosure, trust module 110(n) may be configured to verify a certificate 622 provided by the service provider 102(m) indirectly, e.g. without using root certificates installed on the client 104(n). Client 104(n), via trust module 110(n), may interact with certificate service 134 to verify a certificate 622. While the certificate service 134 is depicted in FIG. 6 as a stand-alone service, it is noted that certificate service 134 may also be incorporated within another service, such as within with proxy service 126 or authentication service 116 of FIG. 1.

Certificate service 134 has a certificate manager module 136 depicted as executed on processor 608 and which is storable in memory 614. Certificate service further includes a certificate store 624 in memory 614. The certificate store maintains one or more signed data packages 626(p) (where “p” may be any number from one to “P”) which may each include a plurality of known good certificates 628(q) (where q may be any number from one to “Q”)

Certificate manager module 136 represents functionality which may be utilized to maintain the certificate store 624 and signed data packages 626(p) including certificates 628(q) within the store, to manage and provide access to the certificate store 624, to interact with clients 104(n) and more particularly with trust module 110(n), and so forth.

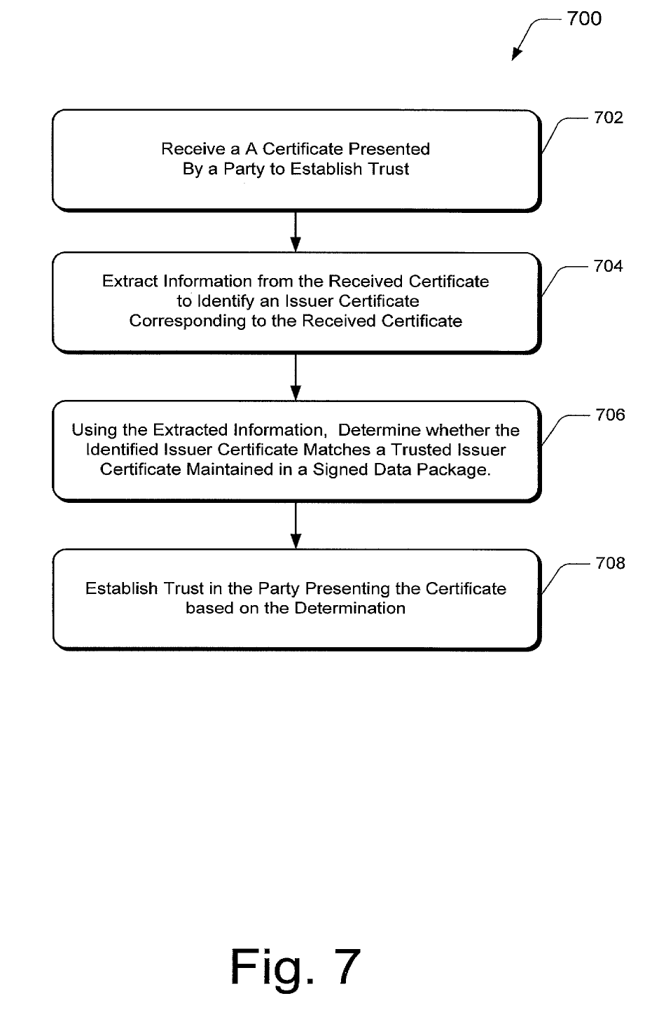

In an implementation, trust module 110(n) is configured to determine if a presented certificate 622 was issued under a known good certificate 628(q) maintained in the certificate store 624. In other words, trust module 110(n) executes on a client 104(n) to establish the identity of an issuer certificate corresponding to the presented certificate 622, and to trace the issuer certificate back to a known good certificate 628(q) of the certificate service 134. By comparing the issuer certificate of an unknown certificate, to the known good certificates 628(q) in a singed data package 626(q), trust of a party presenting the unknown certificate may be established, further discussion of which may be found in relation to the following discussion of FIG. 7.

Exemplary Procedures

The following discussion describes indirect certificate chaining techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the system 600 of FIG. 6.

FIG. 7 depicts a procedure 700 in an exemplary implementation in which a client accesses a certificate service to verify a presented certificate. A certificate to establish trust is received from another party to establish trust (block 702). For example, assume client 104(n) of FIG. 6 is executing an application module 108(n) configured as a web browser. Client 104(n) may be a mobile device such as a cell phone on which user executes a web browser to access an account with a service provider 102(m), for instance an internet banking account. In order to conduct secure internet banking transactions, a secure SSL/TLS session 620 is initiated between the client 104(n) and service provider 102(m). To prove trustworthiness, service provider 102(m) presents a certificate 622 for verification by the client 104(n). In particular, service manager module 112(m) may execute on processor 606 to present the certificate 622 to a client 104(n). Application module 108(n) and more particularly trust module 110(n) may be configured to receive and process the certificate 622. A certificate 622 is shown in phantom as receivable by client 104(n) and storable within memory 610.

Information is extracted from the received certificate to identify an issuer certificate corresponding to the received certificate (block 704). Continuing the preceding example, trust module 110(n) may execute to extract information from the received certificate 622 which may be used to identify the issuer certificate (e.g., the signer of the received certificate used as a basis for trust). A variety of information may be contained in a certificate. In an implementation, a certificate 622 contains information for chaining up to the issuer certificate, for instance at least an identifier associated with each certificate in a chain. A certificate chain results for example when an issuer certificate is used to create another certificate which is used in turn to created another and so on down. A certificate, such as the certificate 622, may have an associated chain of certificates under which it was issued. Information within the certificate 622 may be used to trace back along the chain of certificates under which certificate 622 was issued, such as back to an issuer certificate. If certificate 622 is determined to be issued under a known good certificate then certificate 622 may itself be trusted.

In one or more implementation, a certificate may contain an Authority Key Identifier (AKI) and Authority Info Access (AIA). AKI has the information identifying the key used to sign this certificate and AIA may provide a uniform resource locator (URL) to obtain the issuer certificate. Using AKI and AIA, the issuer of a given certificate may be identified. It is noted that each certificate in a chain may included respective identification information. In an implementation, trust module 110(n) is configured to extract information to identify a plurality of certificates in the chain leading to a certificate, such as certificate 622, using the respective identification information of the various certificates in the chain.

Using information extracted from a received certificate, a determination is made if the identified issuer certificate matches a trusted issuer certificate maintained in a certificate store (block 706). In the preceding example, trust module 110(n) may be configured to determine if the received certificate 622 is traceable to a known good certificate maintained in certificate store 624 on server 618 of certificate service 134. In other words, trust module 110(n) determines if the issuer certificate corresponding to the received certificate 622 is trusted. To accomplish this, trust module 110(n) may communicate via network 106 with certificate service 134 and more particularly with certificate manager module 136. Trust module 110(n) may provide to the certificate service 134 the previously extracted information identifying an issuer certificate corresponding to the received certificate 622. Certificate manager module 136 may be executed to determine if the certificate store 624 contains the identified issuer certificate and to provide trust module 110(n) an indication of whether or not the issuer certificate is trusted.

As previously described a certificate store 624 may maintain one or more signed data package 126(p) which each includes one or more know good certificate 128(q). Signed data package 126(p) may be configured in a variety of ways, such as a dynamic link library (dll), a binary large object (blob), a portion of code, or other data file 126(p) configured to include a plurality of certificates. Further, the signed data package 126(p) as the name suggest is digitally signed, for instance by code signing techniques, to verify that no one tampered with the data package. A variety of singing techniques may be utilized, for instance digital signatures using a public/private key pair algorithm, signing a cryptographic hash of the data, and so forth. One example, of code signing technology suitable for performing the signing is AUTHENTICODE code signing software (Authenticode is a registered trademark of Microsoft Corporation of Redmond, Wash.).

In an implementation, certificate service manager 136 may be executed to perform signing of data package, such as by an administrator of certificate service 134. Additionally or alternatively, certificate service 134 may receive signed data packages 626(p) from a variety of sources, such as from issuers, from certificate authorities (CAs) and so on, which are maintained in certificate store 624.

Further, the signed data packages 626(p) may be readily updateable. Signed data packages 626(p) may be deleted, new data packages 626(p) may be added to the store 624, certificates may be added or removed to update a existing data package 626(p) which may then be re-signed and so on. Such changes to the certificate store 624 may be accessible to a plurality of clients 104(n) to establish trust in received certificates without installing new root certificates to the clients 104(n).

In the signed data package 626(p) there may be multiple certificates which are known good certificates 628(q). These for instance may be certificates signed by trusted certificate authorities CA or otherwise implicitly trusted certificates. The integrity of the digitally signed data package 626(p) and accordingly the certificates 628(q) within signed data package 626(p) may be verified via the digital signature. Accordingly, certificates 628(q) maintained within the data package may be trusted. Since the certificates 628(q) are trusted, is not necessary to trace an unknown certificate 622 back to a root certificate installed on client 104(n).

Although certificate store 624 is depicted in FIG. 6 as implemented by a service, it is noted that client 104(n) may itself maintain a certificate store 624 to determine trustworthiness of a presented certificate 622. A representative certificate store 624 is show in phantom within memory 610 of client 104(n) in FIG. 6. In an implementation, certificate store 624 on client 104(n) contains the plurality of signed data packages 626(p). For instance, one or more signed data package 626(p) configured as a DLL may be download to client 104(n) via network 106. The downloaded DLLs may be updated on demand or on a periodic basis. A certificate service 134 standing alone or incorporated into another service may perform maintenance and updates on the DLLs and may prompt clients 104(n) when updates are available. Thus, a simple updating or download of a DLL may be used to update the known good certificates 628(q) for client 104(n), again without needing to install root certificates.

Trust module 110(n) either through interaction with a certificate service 134, or by accessing a certificate store 624 locally on client 104(n) verifies that the received certificate 622 (e.g., certificate received from the internet banking service) is traceable to a know good certificate maintained in a signed data package 626(p). In other words, the trust module 110(n) determines if the certificate 622 is trustworthy.

Trust in the party presenting the certificate is established based on the determination (block 708). If the received certificate is traceable to a known good certificate, then the received certificate and correspondingly the party presenting the certificate is trustworthy. In the example given previously, the client 104(n) will trust the service provider 102(m) e.g., the internet banking service. In other words, client 104(n) will believe assertions made by the internet banking service, for instance that the internet banking service is who they claim to be. Accordingly, a secure communication channel such as SSL/TLS may be established between the client 104(n) and the service providers 102(m) and the client 104(n) may engage in secure banking transactions.

Establishing secure communications may be dependent upon whether or not parties trust one another. Thus, if in the previous determination the received certificate 622 is not found to be traceable to a known good certificate, then the party (e.g., internet banking service) may not be trusted. In an implementation, trust module 110(n) is be configured to restrict communication with an un-trusted party, such as by preventing or terminating a secure communications session with the party, by providing a warning to a user regarding the un-trusted party, and so forth.

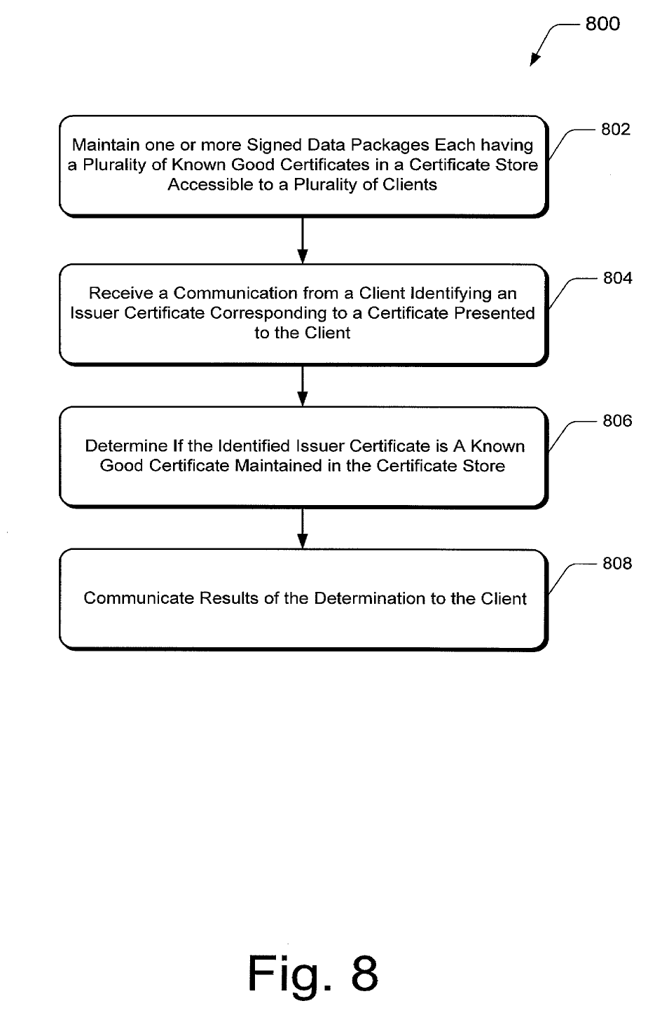

FIG. 8 depicts a procedure in an exemplary implementation in which a certificate service provides a plurality of clients access to one or more signed data packages to verify certificates. One or more signed data packages each having a plurality of know good certificates are maintained in a certificate store accessible to a plurality of clients (block 802). For instance, certificate service 134 of FIG. 6 is depicted as having a certificate store 624 in memory 614 of server 618. The certificate store maintains a plurality of signed data packages 626(p), which may each include a plurality of known good certificates 628(q). A plurality of clients 104(n) may have access to the certificate service 134 via network 106, for instance to verify a certificate 622 presented by a service provider 102(m) to establish trust and to permit an SSL/TLS session 620 between a client 104(n) and the service provider 102(m).

A communication is received from a client identifying an issuer certificate corresponding to a certificate presented to the client (block 804). For instance client 104(n) and in particular trust module 110(n) may form a query which is communicated to certificate service 134 via network 106 The query includes information identifying an issuer certificate extracted from a presented certificate 622 in order to determine if the issuer certificate is trustworthy. Certificate Service 134 receives and processes the query.

In particular, a determination is made whether the identified issuer certificate is a known good certificate maintained in the certificate store (block 806). For example, certificate manager module 136 may be configured to receive and respond to the query from trust module 110(n). Certificate manager module 136 may execute the query or perform a look-up of the issuer certificate in the certificate store 624. In an implementation, certificate manager module 136 may operate to manage and provide a plurality of clients 104(n) access to the certificate store 134, such as by managing and directing queries received by the clients 104(n). In other words, certificate manager module 136 may manage client 104(n) access to the singed data packages 126(p) in the alternative to directly performing queries or the look-ups.

The results of the determination are communicated to the client (block 808). For instance, certificate manager module 136 may be configured to communicate results of the determination (e.g., a response to the query) to client 104(n) via network 106. From the received results, client 104(n) may understand whether the received certificate 622 is trustworthy or not, and accordingly whether the party presenting the certificate should be trusted.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
receiving, at a proxy server, a communication from a client configured to cause the proxy server to perform tasks on the client's behalf;
submitting a request to an authentication server on behalf of the client; and
caching, at the proxy server, one or more security tokens received from the authentication server in response to the request.

2. A method as recited in claim 1 further comprising presenting one said security token to a corresponding service provider at the client's request to permit the client to access services of the service provider.

3. A method as recited in claim 1 wherein at least one said security token is an authentication token configured to prove the client's identity at the authentication server.

4. A method as recited in claim 3 wherein the authentication token is presented by the proxy server to the authentication server in order to obtain additional security tokens.

5. A method as recited in claim 1 wherein the proxy server is configured to route messages between the client and authentication server having encrypted portions which the proxy server is unable to understand.

6. A method as recited in claim 1 further comprising indicating to the client that one or more security tokens received from the authentication server have been cached on the proxy server.

7. A method as recited in claim 1 wherein the client is configured as a mobile device selected from the group consisting of:
a cell phone
a personal digital assistant;
a hand held computing device;
a gaming device; and
a laptop computer.

8. A method comprising:
maintaining, on behalf of a client on a proxy server remote from the client, one or more security tokens configured to prove an identity of the client and received from an authentication service; and
upon request from the client, presenting one said security token on the client's behalf to permit the client to access to corresponding services.

9. The method as recited in claim 8, wherein the one said security token is a service token configured to proof identity of the client at a corresponding service provider.

10. The method as recited in claim 8, wherein the one said token is an authentication token configured to proof identity of the client at the authentication service to receive one or more service token to be cached at the proxy server.

11. The method as recited in claim 8 wherein the authentication token is a limited discretionary access token (LDAT) limiting the service tokens which may be obtained using the LDAT.

12. The method as recited in claim 11, wherein the service tokens which may be obtained using the LDAT are limited based upon the type of client.

13. The method as recited in claim 8, wherein the one said security token may be presented to access services without inputting of user credentials.

14. A method comprising:
receiving at a client a certificate via a network presented by a party to establish trust;
determining whether the received certificate corresponds to a known certificate maintained in a signed data package; and
establishing trust in the party based on the determination.

15. The method as recited in claim 14 wherein if the received certificate corresponds to a known certificate, the party presenting the received certificate is trusted.

16. The method recited in claim 14, wherein the trustworthiness of the received certificate is established without utilizing a root certificate installed on the client.

17. The method recited in claim 14 further comprising extracting information from the received certificate identifying an issuer certificate corresponding to the received certificate, wherein the determining includes using the extracted information to determine if the issuer certificate matches a good certificate contained in the signed data package.

18. The method recited in claim 14, wherein the determining is performed via a certificate store maintaining one or more known certificate in one or more signed data packages.

19. The method recited in claim 18, wherein the certificate store is located on the client.

20. The method recited in claim 14 wherein the signed data package is selected from the group consisting of:
a dynamic link library (DLL);
a portion of code; and
a binary large object (blob)
